(19) United States
(12) Patent Application Publication
(10) Pub. No.: US 2004/0021940 A1
(43) Pub. Date: Feb. 5, 2004

(54) Optical polarization rotating device

(76) Inventors: John E. Gunther, Morgan Hill, CA (US); Afshin Partovi, Redwood City, CA (US); Eric Hansotte, Sunnyvale, CA (US)

Correspondence Address: John E. Gunther, Digilens Inc, 615 Palomar Avenue, Sunnyvale, CA, 94086, US

(21) Appl. No.: 10/209,480

(22) Filed: Jul. 30, 2002

(51) Int. Cl. G02B 5/30; G02B 27/28; G02B 5/04; G02B 7/18

(52) U.S. Cl. 359/487; 359/496; 359/831

(57) ABSTRACT

A polarization rotating optical device is provided. The device comprises a prism configured to accept an input collimated optical beam and redirect the beam by means of total internal reflection at three or more faces of the prism. The first face reflects an incident collimated beam at an angle of 90 degrees with respect to the original beam direction. The incident and reflected beams are comprised of orthogonal s and p polarized components, where the s and p directions are defined with respect to the plane containing the incident and reflected beam directions in the conventional manner. One or more prism faces then reflect the beam within the plane normal to the incident beam. The sum of the included angles of these reflections must total an odd multiple of 90 degrees. The final prism face reflects the beam by 90 degrees in a third plane orthogonal to the planes of the preceding reflection. The resulting exit beam is parallel to the incident beam and has the s and p polarization components are interchanged with respect to the polarization components of the incident beam.

### BACKGROUND OF THE INVENTION

Components for use in fiber optic communications systems must have very low polarization-dependent loss, or PDL. Planar lightwave circuits (PLCs) are particularly susceptible to PDL since the manufacturing processes may introduce stress, and thus birefringence and PDL. One of the approaches used to minimize the PDL of PLCs is the use of a polarization-rotating reflector to reflect the light back through the same waveguide or adjacent waveguide cores on the same planar lightwave circuit. For example, U.S. Pat. No. 6,112,000 describes the use of a polarization-converting reflector to reduce the PDL of a folded array waveguide grating. Polarization rotating reflectors may also be employed to reduce the PDL of other optical components, including optical amplifiers and acousto-optic filters, as described in U.S. Pat. No. 5,481,391and U.S. Pat. No. 6,253,002, respectively.

A polarization-rotating reflector can be assembled from a combination of a one-quarter-wave retardation plate and a mirror, or the combination of a 45-degree Faraday rotator and a mirror. However, the performance of both one-quarter-wave retardation plates and Faraday rotators varies significantly with wavelength and temperature, such that adequately low PDL may not be achieved over the entire spectrum and temperature range of interest for optical communications. Essentially achromatic doublet waveplates can be obtained, but they are much more expensive and still limit the wavelength bandwidth of the planar lightwave circuit.

The present invention is a prismatic polarization rotator that reflects an incident beam with precisely 90-degree polarization rotation of S and P polarization components with very high efficiency and without any dependence on wavelength. The invention is suitable to rotate the polarization of a collimated optical beam in free space, and may be coupled to a planar optical circuit by means of collimating lenses.

### SUMMARY OF THE INVENTION

The invention is a prism configured to accept an input collimated optical beam and redirect the beam by means of total internal reflection at three or more faces of the prism. The first face reflects an incident collimated beam at an angle of 90 degrees with respect to the original beam direction. The incident and reflected beams are comprised of orthogonal s and p polarized components, where the s and p directions are defined with respect to the plane containing the incident and reflected beam directions in the conventional manner. One or more prism faces then reflect the beam within the plane normal to the incident beam. The sum of the included angles of these reflections must total an odd multiple of 90 degrees. The final prism face reflects the beam by 90 degrees in a third plane orthogonal to the planes of the preceding reflection. The resulting exit beam is parallel to the incident beam and has the s and p polarization components are interchanged with respect to the polarization components of the incident beam.

Since the beam is redirected by means of total internal reflection, essentially 100% of the beam power (except for Fresnel reflections at the input and output faces of the prism, which can be minimized by antireflection coatings) is redirected with the s and p polarization components rotated by essentially 90 degrees. The exact amount of the polarization rotation is determined by the angles of the reflective faces and is not dependent on the wavelength of the light. Some configurations of the polarization rotation prism may be fabricated as a single piece, or the polarization rotation prism may be assembled from multiple discrete prism elements.

### BRIEF DESCRIPTION OF THE DRAWINGS

FIG. 1 is a perspective view of a first embodiment of the polarization rotation prism of the present invention.

FIG. 2 is a perspective view of an alternative construction of the first embodiment of the polarization-rotating prism.

FIG. 3 is a perspective view of a second embodiment of the present invention.

FIG. 4 is a chart showing the phase change that occurs between the S polarized and P polarized components of light reflected by total internal reflection.

FIG. 5 is a cross sectional view of a third embodiment of the present invention.

FIG. 6 is a schematic illustration of the polarization rotating prism coupled to a planar lightwave circuit.

FIG. 7 is a schematic illustration of the polarization rotating prism coupled to a birefringent crystal polarization separator.

### DETAILED DESCRIPTION OF THE INVENTION

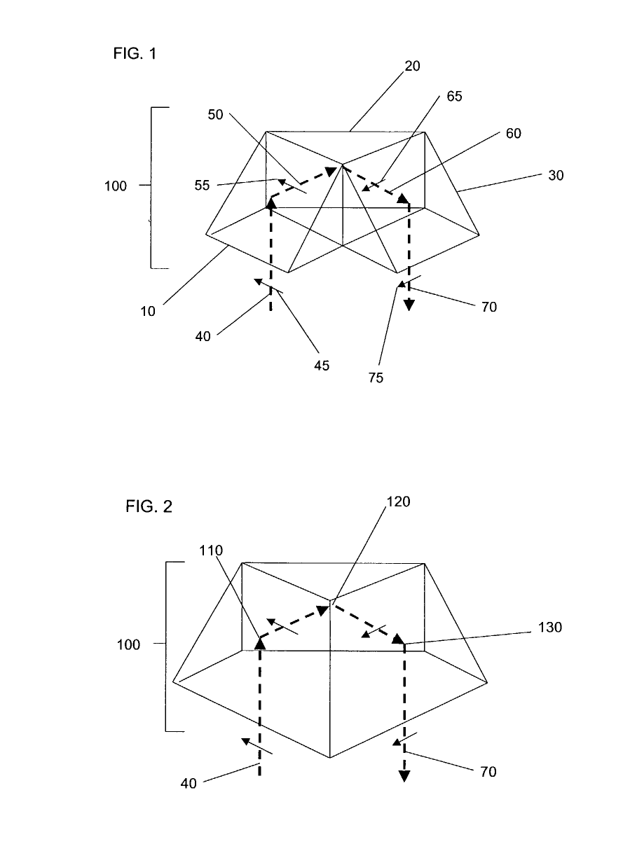

The basic principles of the invention can be understood by considering FIG. 1, which shows a polarization rotation prism 100 assembled from three 45-45-90 prisms 10, 20, 30. The incident beam 40 enters the face of the first prism 10 and is internally reflected by ninety degrees at the hypotenuse of the first prism to form a first reflected beam 50. The incident beam 40 and the first reflected beam define a first plane of reflection. Similarly, the second prism 20 reflects the first reflected beam 50 by ninety degrees to form a second reflected beam 60. The first reflected beam 50 and the second reflected beam 60 define a second plane of reflection that is orthogonal to the incident beam 40. The third prism 30 reflects the second reflected beam 60 by ninety degrees to form an output beam 70. The second reflected beam 60 and the output beam 70 define a third plane of reflection that is orthogonal to the both the first plane of reflection and the second plane of reflection. The resulting output beam 70 is parallel to the incident beam 40.

While the polarization rotation prism 100 can be visualized and constructed as an assembly of three prisms, it can also be fabricated as a single part, as shown in FIG. 2. The operation of the single-piece polarization prism is exactly the same as previously explained. The input beam 40 makes three successive reflections from faces 110,120, 130 of the prism to emerge as output beam 90. The technology for mass production of small precise optics is very mature, and the expected cost of this prism is comparable to that of other polarization rotation optics, such as achromatic wave plates or Faraday rotators.

Referring again to FIG. 1, the effect of the polarization rotating prism on the polarization state of the incident light can be understood by first assuming that the incident beam 40 is linearly polarized along the S direction (the electric field vector is normal to the first plane of reflection), as indicated by arrow 45. The polarization directions of the subsequent reflected beams are indicated by arrows 55, 65, 75. It can be seen that the polarization direction of the output beam 70 is rotated by 90 degrees with respect to the polarization direction of the input beam 40. Similarly, it can be shown that the polarization direction of a P polarized input beam would also have been rotated by 90 degrees. Moreover, it can be seen that the polarization direction of output beam 70 is rotated by exactly the included angle between the first reflected beam 60 and the second reflected beam 70, which is equal to the included angle of the reflection within the second prism 20. Thus the tolerance on the polarization rotation angle is defined by the mechanical tolerances on the prism elements without any dependence on the wavelength of the incident light.

Each of the three internal reflections within the prism imparts a phase change to the reflected light. The phase change upon total internal reflection is discussed by Born and Wolf in Principles of Optics, Cambridge University Press, 7th edition, 1999, pages 52-3. In particular, the amount of the phase shift for the S and P polarization states is given in equation (60). Since the phase change angle is different for the S and P polarization states, there will be a phase difference between the S and P components in the reflected beam. This phase difference between the S and P components is given by Born and Wolf in equation (61), which is reproduced below:

$$δ = 2 {tan}^{- 1} ( \frac{cos {θ}_{i} \sqrt{{sin}^{2} {θ}_{i} - {n}^{2}}}{{sin}^{2} {θ}_{i}} )$$

where: δ is the phase shift between the S and P components,

θᵢ is the incidence angle, and

n is the refractive index of the material.

While this phase difference is irrelevant if the input light is linearly polarized along the S or P direction, the phase difference will have a significant effect if the input light beam is comprised of both S and P components. For example, assume that the input light beam 40 is linearly polarized with the polarization axis at a 45-degree angle to the S and P directions. In this case, the input beam is comprised of equal S and P components that are exactly in phase. The output beam 70 will also be comprised of equal S and P components, each of which has been rotated by 90 degrees. However, since the prism imparts a significant phase difference between the S and P components, the output beam 70 will be elliptically polarized.

Referring again to FIG. 1, it can be seen that the input beam 40 having polarization direction indicated by arrow 45 is in the S polarization state (the polarization vector is normal to the plane of reflection) with respect to the first reflection at the face of prism 10. However, the first reflected beam 50 having polarization direction indicated by arrow 55 is in the P polarization state (polarization vector parallel to the plane of reflection) with respect to the second reflection at the face of prism 20, such that the phase shifts at the first and second reflections will cancel. Thus the phase shift between the S and P components of the output beam 70 will be equal to the phase shift incurred at the third reflection. This phase shift can be reduced, but not eliminated, by providing a metallic reflective coating on the face of either prism 10 or prism 30. The phase shift can be reduced to essentially zero over a narrow wavelength band by providing a suitably designed multilayer reflective coating on the face of prism 10 or prism 30. Such coatings are well known in the art and may be designed and optimized with the aide of available software tools.

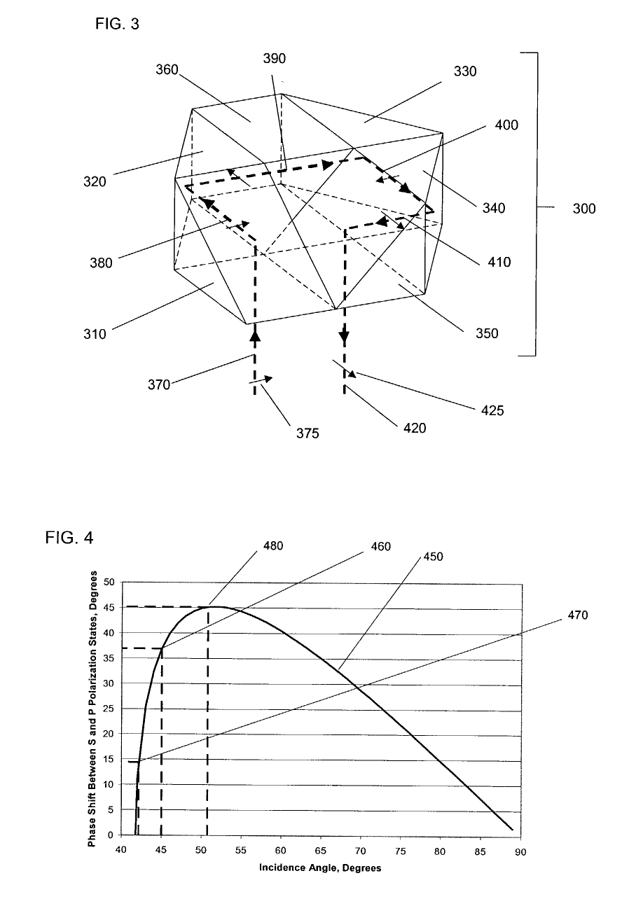

FIG. 3 shows an alternative embodiment of a polarization rotation prism 300 assembled from five 45-45-90 prisms 310, 320, 330, 340, 350 and a transparent spacer block 360. The incident beam 370 enters the face of the first prism 310 and is internally reflected by ninety degrees at the hypotenuse of the first prism to form a first reflected beam 380. The incident beam 370 and the first reflected beam 380 define a first plane of reflection. The second prism 320 reflects the first reflected beam 380 by ninety degrees to form a second reflected beam 390. The first reflected beam 380 and the second reflected beam 390 define a second plane of reflection that is orthogonal to the incident beam 370. Similarly, the third prism 330 and fourth prism 340 also reflect the beam within the second plane of reflection to form a third reflected beam 400 and fourth reflected beam 410, respectively. The final prism 350 reflects the fourth reflected beam 410 by ninety degrees to form an output beam 420. The fourth reflected beam 410 and the output beam 420 define a third plane of reflection that is orthogonal to the both the first plane of reflection and the second plane of reflection. The resulting output beam 420 is parallel to the incident beam 370.

Still referring to FIG. 3, the effect of the polarization rotating prism on the polarization state of the incident light can be understood by first assuming that the incident beam 370 is linearly polarized along the S direction (the electric field vector is normal to the first plane of reflection), as indicated by arrow 375. The polarization directions of the subsequent reflected beams are also indicated by arrows. It can be seen that the polarization direction of the output beam 420, as indicated by arrow 425, is rotated by 270 degrees with respect to the polarization direction of the input beam 370. Similarly, it can be shown that the polarization direction of a P polarized input beam would also have been rotated by 270 degrees. Moreover, it can be see that the polarization direction of output beam 420 is rotated by exactly the included angle between the first reflected beam 380 and the fourth reflected beam 410, which is equal to the total of the included angles of the reflections within the second, third and fourth prisms 320, 330, 340. Since the sign of the e-field vector is generally not important in optical systems, a rotation of the polarization direction by 270 degrees is functionally equivalent to a rotation by 90 degrees, both rotations having the desired effect of reversing the S and P component of the input beam to form the output beam.

Still referring again to FIG. 3, it can be seen that the input beam 370 having polarization direction indicated by arrow 375 is in the S polarization state (the polarization vector is normal to the plane of reflection) with respect to the first reflection at the face of prism 310. However, the first reflected beam 380 is in the P polarization state (polarization vector parallel to the plane of reflection) with respect to the reflections at the face of prisms 320, 330, and 340. The fourth reflected beam 410 is in the S polarization state for the final reflection at the face of prism 350. Thus the phase shifts at the first and fifth reflections are canceled by two of the three intermediate reflections, such that the phase shift between the S and P components of the output beam 420 will be equal to the phase shift incurred at a single 90-degree internal reflection. This phase shift can be reduced, but not eliminated, by providing a metallic reflective coating on the face of prism 320, prism 330, or prism 340. The phase shift can be reduced to essentially zero over a narrow wavelength band by providing a suitably designed multilayer reflective coating on the face of prism 10 or prism 30.

In many applications, it is necessary to rotate the polarization of a beam without any phase change between the S and P components. This can be accomplished by balancing the phase changes that occur at the multiple reflections within a modified version of the previously described five-reflection prism. First consider FIG. 4, which graphs the phase shift between the S and P polarization components of a totally reflected beam as a function of the incidence angle at reflection. This chart was specifically calculated for BK-7 optical glass at wavelengths around 1550 nm, but other glasses and wavelengths will have similar characteristics. The phase shift is zero at the critical angle for total internal reflection, about 42 degrees in this example. The phase shift then increases rapidly with increasing angle, reaches a maximum, and then decreases to zero when the incidence angle reaches 90 degrees.

Recalling the discussion of FIG. 3, remember that light that is S polarized at the first and fifth reflection, is P polarized at the three intermediate reflections. Thus the numerical sign of the phase shift at the first and fifth reflection will be opposite that of the phase shift at the intermediate reflections. A polarization rotation prism that provides the equivalent of 90 degree polarization rotation without any phase shift between the S and P polarization components can be realized if the reflection angles comply with the following requirements:

Θ1=Θ5=90;

Θ2+Θ3+Θ4=90n (n=an odd integer); and

Φ1+Φ5=Φ2+Φ3+Φ4;

where Θi is the included angle at the i'th reflection, and Φi is the unsigned magnitude of the phase shift between the S and P polarization components at the i'th reflection.

Referring again to FIG. 4, note the point 460 on the curve showing that an incidence angle of 45 degrees results in a phase shift of about 37 degrees between the S and P components of the reflected beam. Similarly, an incidence angle of about 51 degrees produces a phase shift of 45 degrees (point 480) and an incidence angle of about 42 degrees produces a phase shift of 14.5 degrees (point 470). Thus the combination of one reflection with an incidence angle of about 51 degrees and two reflections having incidence angles about 42 degrees will have a total included angle of 2(51+42+42)=270 degrees and a total phase shift of 45+14.5+14.5=74 degrees, which is equal to the phase shift of 2×37 =74 degrees produced by two reflections with 45 degree incidence.

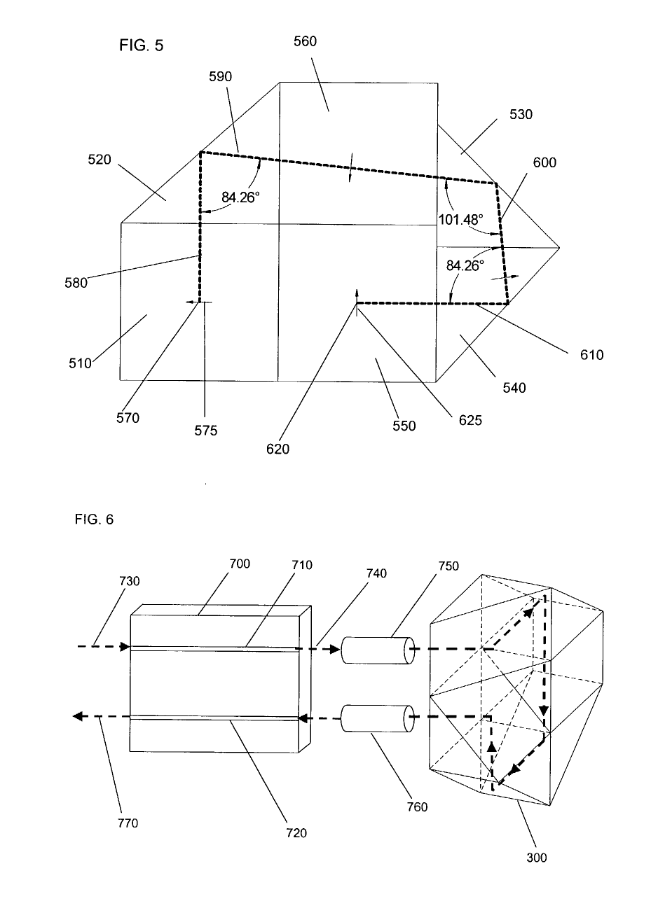

FIG. 5 illustrates a cross-section of a five-reflection polarization rotating prism in the plane normal to the input and output beams. This prism is similar to that previous illustrated in FIG. 3, but uses the angles selected in the previous paragraph. The polarization rotation prism is comprised of five right-angle prisms 510, 520, 530, 540, 550, and a transparent spacer block 560. Prisms 510, 530 and 550 are 45-45-90 prisms. Prisms 520 and 540 have an acute angle of 42.13 degrees. The incident beam 570, which is normal to the plane of the drawing and has a polarization state illustrated by arrow 575, enters the face of the first prism 510 and is internally reflected by ninety degrees at the hypotenuse of the first prism to form a first reflected beam 580. The second prism 520 reflects the first reflected beam 580 by 84.26 degrees to form a second reflected beam 590. The first reflected beam 580 and the second reflected beam 590 define a second plane of reflection that is orthogonal to the incident beam 570. Similarly, the third prism 530 reflects the second reflected beam 590 by an angle of 101.48 degrees to form the third reflected beam 600, and the fourth prism 540 reflects the third reflected beam 600 by an angle of 84.26 degrees to form the fourth reflected beam 610. The final prism 550 reflects the fourth reflected beam 610 by ninety degrees to form an output beam 620, which is also normal to the plane of the drawing. The resulting output beam 620 is parallel to the incident beam 570 The polarization state of the output beam 620, as indicated by arrow 625, is rotated by 270 degrees with respect to the polarization state of the input beam 570, but without any relative phase shift between the S and P components of the output beam.

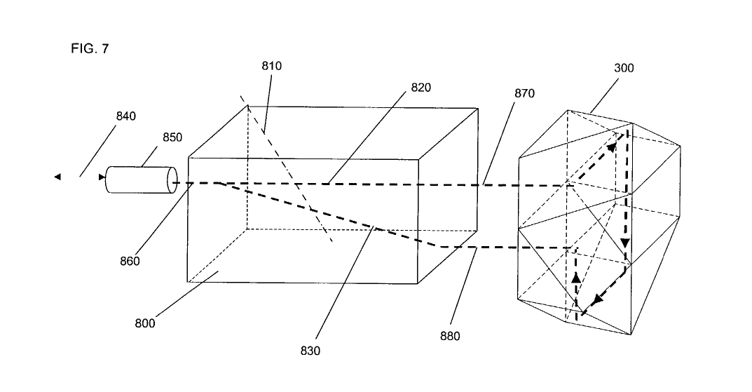

A schematic diagram of a planar lightwave circuit (PLC) coupled to the prismatic polarization rotator is shown in FIG. 6. The PLC 700 has a first optical waveguide 710 and a second optical waveguide 720. An optical input signal 730 is coupled into one end of the first waveguide 710. The optical signal propagates down the length of waveguide 710 and is modified in some way by the PLC. Possible signal modifications that may occur in the PLC include wavelength dependent attenuation or filtering. The effect of the PLC may not be exactly the same for all polarization states, resulting in some Polarization Dependent Loss (PDL) in the signal 740 exiting the first waveguide core.

The optical signal 740 exiting the first optical waveguide is collimated by the first lens 750, reflected by the polarization rotation prism 300, and focused by the second lens 760. The action of polarization rotating prism 300 is exactly as explained previously in the discussion of FIG. 3. The reflected optical signal enters the second optical waveguide 720 with polarization state rotated by 90 degrees. The optical signal propagates down the length of the second optical waveguide 720 and is further modified by the PLC. Assuming that the effects of the first optical waveguide 710 and the second optical waveguide 720 are essentially identical, the PDL introduced in the first waveguide is canceled by the PDL of the second waveguide, such that the output optical signal 770 has very low net PDL.

In many applications, (see previously-referenced U.S. Pat. Nos. 5,481,391; 6,253,002; and 6,375,913), it may be preferred for the polarization-rotating reflector to reflect the input light along the same optical path or optical fiber. This can be accomplished with the addition of a birefringent crystal beamsplitter, as shown in FIG. 7.

A birefringent crystal beam splitter is comprised of a uniaxial birefringent crystal cut with the extraordinary axis at an angle (typically 45 degrees) to the direction of light propagation. The birefringent crystal beamsplitter, commonly called a walk-off crystal, is a well-known component often used in fiber optic isolators and circulators. Since the crystal is cut such that the extraordinary axis is at an angle to the direction of light propagation, light propagating through the crystal is divided into orthogonal polarized p and s components that propagate at different angles within the crystal. The angle between the two beams is about 7 degrees for Yttrium Vanadate crystals. The length of the birefringent crystal is selected such that the p component and the s component are physically separated when they exit the crystal as parallel linearly polarized beams.

To understand the function of the device shown in FIG. 7, consider first only the P polarized component of a light signal introduced by optical fiber 840. The P component is collimated by lens 850 and enters the birefringent crystal 800, which is cut with the crystal axis 810 at an angle to the direction of beam propagation. The p component follows path 820 through the crystal 800 and exits as beam 870. The beam 870 enters the polarization rotation prism 300 and is reflected with a ninety-degree rotation of the polarization vector, as previously explained during the discussion of FIG. 3, to form the reflected s-polarized beam 880. Since the reflected beam is now s-polarized, the light follows path 830 through the birefringent crystal 800. Assuming that the length of the birefringent crystal 800 and the dimensions of the polarization rotation prism 300 have been selected properly, the S-polarized beam will exit the birefringent crystal along the same axis 860 as the input beam. The reflected S-polarized beam will be focused by lens 850 and coupled into fiber 840 propagating in the opposing direction to the input optical signal. It should be clear that the s-component of the optical input signal will propagate through the birefringent crystal and polarization rotation prism in the opposite direction of the p-polarized component and will also be returned to fiber 840 after a ninety-degree rotation of the polarization vector.

Thus the device illustrated in FIG. 7 reflects the optical signal from fiber 840 back into fiber 840 with the s and p polarization components both rotated by ninety degrees. This device performs a similar function as a Faraday rotator and mirror combination, but with almost no dependence on the wavelength of the optical signal.

The polarization rotating prism has advantages over the use of a wave plate or Faraday rotator in conjunction with a mirror. First, the polarization rotating prism is truly achromatic. It can be used to interchange the S- and P-polarized components of an optical beam for any wavelength where the prisms are essentially transparent. With antireflection coatings on the input/output face, the efficiency of the polarization rotation prism will approach 100%, assuming that it is packaged in a manner that the total internal reflection faces are kept clean. In addition, the five-reflection version of the prism can provide a relative phase change between the S and P components of less than 0.1 degrees for a single wavelength over a 100-degree Celsius temperature range, and less than one-degree relative phase change over a 130 nm bandwidth. Finally, unlike the conventional polarization-rotating reflector based on a mirror, the incident and exit beams of the polarization-rotating prism are parallel and displaced by a controlled distance. These beams can be easily coupled to parallel waveguide cores.

While the most practical and preferred embodiments of the invention have been described, it is to be understood that the invention is not limited to the disclosed arrangements but rather is intended to cover various modifications and equivalent constructions included within the spirit and scope of the invention.

What is claimed is:

1. An optical polarization rotating device comprising:
a transparent prism element having an entrance face disposed to admit an input optical beam and three or more reflective faces for sequentially reflecting said optical beam by means of total internal reflection, said three or more reflective faces further comprising:
a first reflective face for reflecting said optical beam through an angle of 90 degrees,
one or more intermediate reflective faces for sequentially reflecting said optical beam within the plane normal to said input optical beam, wherein the total included angle of the reflections at said one or more intermediate reflective faces is an odd multiple of 90 degrees, and
a final reflective face for reflecting said beam through an angle of ninety degrees within a plane parallel to said input beam,
whereby the beam reflected from the final reflective face constitutes the output beam, said output beam being parallel to and displaced from said optical input beam, and whereby the principle polarization states of said output beam are rotated by an odd multiple of ninety degrees with respect to the corresponding polarization states of said input optical input beam.

2. The optical polarization rotating device of claim 1, wherein the number of intermediate reflective faces is one.

3. The optical polarization rotating device of claim 2, further comprising an optical coating disposed on either said first reflective face or said final reflective face, said optical coating being designed to reduce the relative phase shift between the S and P polarization components of the reflected beam.

4. The optical polarization rotating device of claim 1, wherein the total number of intermediate reflective faces is three.

5. The optical polarization rotating device of claim 4, further comprising an optical coating disposed on any one of said intermediate reflective faces, said optical coating being designed to reduce the relative phase shift between the S and P polarization components of the reflected beam.

6. The optical polarization rotating device of claim 4, wherein the sum of the included angles of the reflections at said intermediate reflective faces is 270 degrees, and the angles of said reflection are selected such that the total phase shift between the S and P components in the input beam is equal in magnitude to the total of the phase shifts incurred at said first reflective surface and said final reflective surface.

7. The optical polarization rotating device of claim 6, wherein said transparent prism element is constructed of BK-7 glass, and the included angle of two of said intermediate reflective faces is about 84.3 degrees.

8. The optical polarization rotating device of claim 1, further comprising a birefringent prism polarization beam separator/combiner disposed adjacent to said entrance face of said transparent prism element, said polarization beam separator/combiner configured to divide an optical beam into parallel orthogonally-polarized components coaxial with the input beam and the output beam of said transparent prism element.

9. The optical polarization rotating device of claim 1, further comprising:
a planar lightwave circuit having a surface and an end face, and a first optical waveguide and a second optical waveguide disposed on said surface and terminating at said end face, said planar lightwave circuit disposed with said end face proximate to said entrance face of said transparent prism element;
a first lens disposed between said end face and said entrance face, said first lens configured to collimate light exiting said first optical waveguide to form the optical input beam to said transparent prism element, and
a second lens disposed between said end face and said entrance face, said second lens configured to focus the output beam from said transparent prism element and couple said beam into said second waveguide core
